(19) United States
(12) Patent Application Publication
(10) Pub. No.: US 2008/0214225 A1
(43) Pub. Date: Sep. 4, 2008

(54) Method For Controlling the Transmission Power of a Mobile Terminal in a Cellular Radio System and a Terminal For Carrying Out Said Method

(76) Inventors: David Choukroun, Le Chesnay (FR); Christophe Gruet, Elancourt (FR); Eric Georgeaux, Montigny Le Bretonneux (FR); Sarah Boumendil, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 11/662,445

(22) PCT Filed: Sep. 8, 2005
(86) PCT No.: PCT/EP2005/009664

§ 371 Date: Mar. 24, 2008

(30) Foreign Application Priority Data
Sep. 9, 2004 (FR) 0409578

(51) Int. Cl. H04Q 7/20

(52) U.S. Cl. 455/522

(57) ABSTRACT

The invention relates to a cellular radio system wherein a communication terminal receives servo power instruction from a base station with which a radio communication comprising first uplink and downlink channels is established. In response to an instruction for changing a channel (13), the terminal records a first power level received from the base station and a reference power on which the terminal transmitted when the instruction was received. The terminal endeavours to continue communication on new uplink and downlink channels interrupting the transmission on the first uplink channel. If failed, the terminal evaluates a second power level received from the base station and restarts to transmit through the first uplink channel at a power determined according to the reference power and a variation between the first and second power level.

The present invention relates to cellular radio communication systems and more precisely to the intercellular transfer of a radio link set up between a terminal and an access network.

In such cellular systems there is provided a process whereby a mobile terminal can change radio channel whilst continuing a call in progress. Such channel transfer processes are usually known as “handovers”.

Intercellular handover, which occurs when a movement of the terminal causes it to change cell within the access network, is distinguished from intracellular handover, where the new channel is in the same cell as the old one.

A distinction is also made between soft handover (SHO), in which multiple radio links are set up simultaneously between the terminal and a plurality of adjacent cells for a certain time, which ensures call continuity and reception diversity in the transient phase, and hard handover (HHO), in which the call on the first channel is broken off when the terminal switches to the second channel. A special case of SHO is that of “softer handover” (SerHO), in which the cells to which the multiple radio links in SHO relate are defined by a common base station.

Such cells correspond to sectors of a multisector base station, for example.

SHO and SerHO mechanisms are provided in Universal Mobile Telecommunication System (UMTS) networks, for example.

HHO mechanisms are provided in Global System for Mobile communication (GSM) and UMTS networks in particular. An HHO may also be operative between a GSM type access network and a UMTS type access network or vice-versa. In this case, the handover is between two different access technologies, also known as inter-radio access technology (inter-RAT) handover.

The cell transfer is generally initiated on the basis of predetermined criteria relating to the transmission quality on the radio link between the terminal and the access network. In order to check that a radio link satisfies required quality criteria, different measurements are performed in relation to the cell of the radio link, the radio link itself, or one or more adjacent cells. In the GSM, respectively UMTS, system, a control unit called the base station controller (BSC), respectively the radio network controller (RNC), is responsible for initiating handover when the required criteria are satisfied. A handover may also be initiated as a function of network engineering criteria adopted by the operator. For example, intracellular handovers may be started in the context of reconfiguring radio links for the purpose of optimizing the use of the resources available in a cell. Inter-RAT handovers may also be decided on in order to give preference to orienting a particular type of call toward a particular type of radio access network (for example speech traffic to a GSM network) and another type of call to another type of access network (for example a data call to a UMTS network).

A mobile communication service of high quality relies in particular on the performance of the handover procedure, which must be transparent for a subscriber involved in a call. The most critical of the handovers cited above is HHO, during which the call set up between the terminal and the network is momentarily interrupted.

In order to limit the time of interruption of the call during an HHO, on receiving a handover command, the terminal generally starts a timer and attempts to continue the call on the second radio channel. Then, if the call has not been able to continue on the second radio channel when the timer expires, the terminal attempts to return to the radio channel or channels previously in use.

A problem that arises in this case is that of the power with which the terminal should resume transmission over the radio interface on returning to the old channel or channels. The transmission power of the terminals is generally controlled by the network by means of a feedback loop. The signal level received from the terminal and/or the quality of that signal are evaluated by the network which accordingly sends it instructions to increase or decrease its transmission power. However, in the phase of a HHO in which the terminal has ceased to transmit on the old channel or channels, this feedback loop is interrupted, and when the terminal returns to the old channels if the HHO fails, it no longer knows with what power to transmit.

This problem arises in particular in systems such as the UMTS where the power control speed and dynamic range are relatively high. If the terminal resumes transmission with an insufficient power, there is a risk of permanent breaking off of the call, perceived by the user as a discontinuity of service. If the terminal resumes transmission with an excessive power, it causes undesirable interference for the calls in progress of other users.

An object of the present invention is to solve or at least to reduce the impact of this problem by proposing a simple mechanism enabling the cellular radio communication system to re-establish the initial radio link quickly and efficiently after an HHO failure.

A first aspect of the present invention proposes a method of controlling the transmission power of a mobile terminal in communication in a cellular radio system, the terminal receiving power control commands from at least one base station of the cellular system with which a radio link comprising first dedicated uplink and downlink channels is set up, the method comprising the following steps:

in response to the reception by the terminal of a command to change channels, storing a first power level captured from said base station and a reference power with which the terminal was transmitting on the first uplink channel at the time of receiving said command and attempting to continue the call on new dedicated uplink and downlink channels, the terminal ceasing to transmit on the first dedicated uplink channel;

if the continuation of the call on the new channels fails, estimating a second power level captured from said base station and resuming transmission from the terminal on the first dedicated uplink channel with a power level determined as a function of the stored reference power and an observed variation between said first and second power levels.

The present invention covers the various types of HHO.

In general, in a cellular system, a power control loop is created between the terminal and the access network in order to enable the terminal to adapt its transmission power to the configuration of the cell via which it is connected to the access network. A hard handover breaks the power control loop which ensures a match between the transmission power of the terminal, the quality of the call and the propagation attenuation, or “pathloss”. The present invention advantageously enables the terminal to determine a new transmission power after an HHO which has failed in order to reduce the effect of this power control loop interruption.

Once the continuation of the call on the new channels has failed, the terminal determines the new power with which it will transmit its first message on the first dedicated uplink channel in order to re-establish the call with the access network. This calculation takes into account, on the one hand, the power level with which the terminal was sending at the time of reception of the HHO command and, on the other hand, a variation of the power level captured from the base station between the time at which the HHO command was received and the time at which the terminal reverts to its first dedicated uplink channel after the failure of the HHO. The terminal is then in a position to send again with a power matched to the new configuration in which it finds itself after the failure of the hard handover. In fact, the transmission power calculated in this way can be well matched since it takes into account changes that may have occurred during the handover attempt.

If a terminal sends a signal with too weak a power, the access network does not receive the signal transmitted. If the terminal that is attempting to re-establish the call with the access network via the first uplink channel sends a signal with too weak a power, the call between the terminal and the access network is interrupted for longer and the call may be permanently lost.

Accordingly, a calculation of the transmission power in accordance with one embodiment of the present invention prevents the terminal from transmitting with too weak a transmission power and thereby favors re-establishing the call with the access network via the first radio channel.

Conversely, if a terminal transmits with an excessive power in a given cell, it impacts negatively on the capacity and the quality of the calls in progress in the cell by generating unwanted interference on the other radio links. Such a power calculation may also prevent transmitting with too high a power in the first cell.

Taking account of the new power level captured from the base station after the failure of the HHO in the calculation of the new transmission power may in particular prove very advantageous if the terminal is moving at high speed. In fact, in this case, the propagation losses between the terminal and the base station of the first cell to which it is connected may suffer significant variations between the time at which the terminal launches the required HHO and the time at which it attempts to re-establish the call via the first dedicated channel. Note that in 500 ms a terminal moving at 100 kph in fact travels around 10 meters, which can lead to great variations in pathloss.

In general, in a cellular system, a mobile terminal placed in a coverage area of a base station receives a signal transmitted by the base station on a common downlink channel.

Thus the mobile terminal can determine the first and/or the second power level captured from the base station from the power of this signal transmitted on the common downlink channel.

The mobile terminal can also determine the first and/or the second power level captured from the base station by calculating an energy received from the base station in a defined frequency band over a given time period on the common downlink channel.

The terminal may be executing an SHO and/or an SerHO when it receives the HHO command. In this kind of configuration, a plurality of radio links is established between the mobile terminal and one or more base stations at the time of receiving the command to change channels. In general, a beacon signal or pilot signal is broadcast by the base station or stations on respective common downlink channels in the various cells concerned. The terminals that receive this beacon signal determine a power level received from the base station.

In such a case, the terminal can determine the first power level, to be stored before the HHO attempt, by combining some or all of the power levels captured from said base stations. If the continuation of the call on the new channels fails, the terminal can also estimate the second power level by combining some or all of the power levels captured from the base stations once the continuation of the call on the new channels has failed.

Thus the terminal can determine its new transmission power by advantageously taking into account the various signal power levels received from each of the base stations with which it has established at least one radio link.

Once the continuation of the call on the new channels has failed, the mobile terminal can determine a transmission power level as a sum of the variation observed between the first and second power levels, the stored reference power, and a positive or zero power offset value. The power offset value may be obtained from signaling information received from the base station.

It may further take into account a configuration parameter or other information received from the base station, for example information indicating an interference level relating to the call with the base station.

A second aspect of the present invention proposes a mobile terminal transmission power control device comprising processing means adapted to implement the method according to the first aspect of the invention.

A third aspect of the present invention proposes a mobile radio communication terminal comprising:

means for communicating with at least one base station of a cellular radio system on a radio link comprising first dedicated uplink and downlink channels, the communication means comprising means for controlling the transmission power on the first dedicated uplink channel as a function of power control commands received from said base station;

means for storing, in response to the terminal receiving a command to change channels, a first power level captured from said base station and a reference power with which the terminal was transmitting on the first uplink channel at the time of receiving said command and attempting to continue the call on new dedicated uplink and downlink channels, the terminal ceasing to transmit on the first dedicated uplink channel;

means for estimating, if the continuation of the call on the new channels fails, a second power level captured from said base station once the continuation of the call on the new channels has failed and resuming transmission on the first dedicated uplink channel with a power level determined as a function of the stored reference power and an observed variation between said first and second power levels.

Other aspects, objects and advantages of the invention will become apparent on reading the following description with reference to the appended drawings of one embodiment of the invention.

The invention will also be better understood with the aid of the following description with reference to the appended drawings, in which:

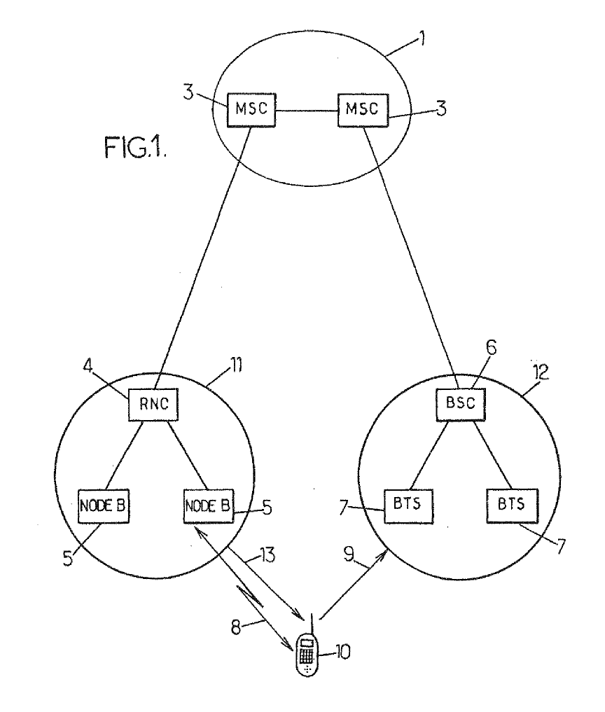

FIG. 1 is a block diagram of a UMTS/GSM mixed cellular radio communication system suitable for the implementation of the invention; and

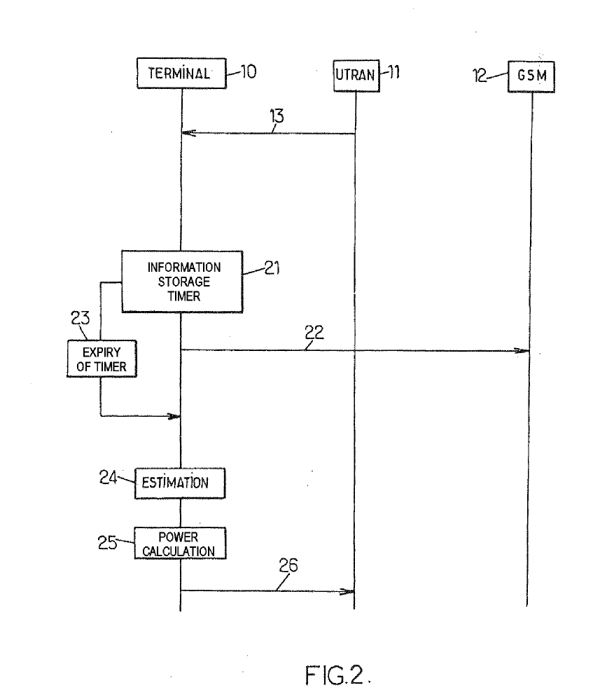

FIG. 2 shows the main steps of one embodiment of the present invention.

The invention is described hereinafter in its application to UMTS type third generation systems and more precisely in a case of hard handover (HHO) between different access technologies. It will be noted that the features of the invention described hereinafter are easily transposed to other types of cellular system, as well as to other types of handover. The UMTS system is standardized in the specifications published by the 3rd Generation Partnership Project (3GPP).

The scenarios of handover in a UMTS system are described in the 3GPP technical specification TS 25.832 “Manifestations of Handover and SRNS Relocation (Release 4)”, version 4.0.0, published in March 2001. The measurement capacities of a UMTS terminal are defined in the 3G technical specification TS 25.215 “Physical layer—Measurements (FDD) (Release 5)”, version 5.0.0, published in March 2002.

A UMTS terminal is capable of providing different measurements relating to each neighbouring cell, in particular from a unidirectional common physical channel from the base station of the cell, called the common pilot channel (CPICH). Thus a terminal can measure the power level of a signal received in a cell on its CPICH channel. That measurement is called the received signal code power (CPICH_RSCP). It can also measure an energy per chip received from the cell referred to the noise power. This measurement is denoted CPICH_Ec/N₀.

The above measurements are used in particular in the cell selection and handover processes. A terminal in communication with a cell or a set of cells in SHO (active set) then measures the CPICH_Ec/N₀ and/or the CPICH_RSCP ratio for a certain number of neighbouring cells (monitored set) which are designated by the infrastructure. Such measurements enable the link control procedures executed in the access network to estimate a quality level for each cell at a given time and thus to select the most appropriate cells to serve the terminal.

FIG. 1 shows a core network 1 cooperating with a radio access network 11 of UMTS terrestrial radio access network (UTRAN) type and a GSM radio access network 12. The core network comprises interconnected switches comprising second and third generation circuit-mode switches called mobile switching centers (MSC 3) and/or second and third generation packet-mode switches called serving GPRS support nodes (SGSN).

The UMTS access network 11 comprises radio network controllers (RNC) each connected to respective base stations (Node B) 5. The GSM access network 12 comprises base station controllers (BSC) 6 that are functionally comparable to the RNC, each connected to respective base transceiver stations (BTS) 7.

In the example represented in FIG. 1, a UMTS/GSM dual mode mobile terminal 10 is in communication via a bidirectional radio link 8 set up between a mobile terminal 10 and the Node B 5. The radio link comprises dedicated uplink and downlink traffic channels.

In the example considered, the invention comes into play in a situation where the mobile terminal 10 receives an inter-RAT HHO command 13 via the base station 5 requiring a change of channel from the UMTS access network 11 to the GSM access network 12.

On reception of this command 13, the terminal executes a certain number of steps that will be described in detail hereinafter with reference to FIG. 2. In particular, the terminal starts a timer TO. It then attempts to communicate with the GSM radio access network 12 on the new channels indicated in the command, ceasing to send on the dedicated uplink channel (HHO case).

If, for whatever reason, the terminal has not succeeded in continuing the call with the radio access network 12 on the new radio channels when the timer T0 expires, this is a case of HHO failure. The terminal then attempts to revert to the initial dedicated channels to resume the call. It also sends a “handover failure” message informing the access network of the failure of the hard handover.

The power with which the terminal resumes transmitting in one embodiment of the present invention is calculated so that it is suited to the new conditions in which the terminal finds itself in relation to the initial base station 5 after the failure of the HHO.

FIG. 2 shows various steps for determining this new transmission power.

The terminal 10 in communication via an initial radio link set up with the access network 11 receives the HHO command message 13. On reception of this message (step 21), the terminal 10 activates the timer T0, the duration of which is typically a few hundred milliseconds, and stores information relating to the initial cell, including:

the power with which it was sending on the dedicated uplink channel at the time of receiving the command 13. That power is controlled in a known manner by the power control loops implemented in the UMTS network;

a first power level captured in the cell of the access network 11 served by the base station 5. This power level is typically measured on the corresponding CPICH channel, but may also be measured on another common channel or a dedicated channel;

information regarding synchronization of the call with the initial cell, for example in the form of an offset between a frame counter kept up-to-date in the terminal and a reference frame counter broadcast by the cell.

The terminal then ceases to transmit on the first dedicated uplink channel and attempts to continue the call with the access network 12 on the designated new channels. If the timer T0 expires 23 without it having been possible for the call to resume on those new channels, the HHO is detected as having failed. The terminal then reverts to the first radio channels. For this purpose, it estimates a second power level captured from the cell served by the base station 5 (for example on the CPICH), and synchronizes with it again using the stored synchronization information and by virtue of the fact that it has not ceased to increment regularly its frame counter.

From information previously stored and from the estimate (24) of the second power level, the terminal determines (25) the transmission power with which it will resume sending on the first dedicated uplink radio channel.

In one embodiment of the present invention, the power level captured from a cell of the radio access network 11 corresponds to the measurement denoted CPICH_RSCP defined hereinabove. Thus CPICH_RSCP_{before} denotes a measurement of the power of the signal received on the CPICH from the base station 5 effected before the HHO attempt and CPICH_RSCP_{after} denotes a measurement of the power of the signal received on the CPICH from the base station 5 effected after the HHO failure.

In this case, the transmission power of the terminal on the dedicated uplink channel after the handover attempt has failed, denoted P_{after}, preferably satisfies the following equation:

P_{after}=P_{before}−(CPICH_{—}RSCP_{after}−CPICH_{—}RSCP_{before})+D (1)

in which P_{before} is the stored reference power with which the terminal was transmitting at the time of receiving the HHO command and D is a predetermined power offset. The offset D has a positive value to reduce the probability of call loss.

This value may be zero, however. The value of D is either defined once and for all in the terminal or signaled to the latter by the access network 11, for example in system information broadcast over the radio interface, in the call set-up signaling or in the HHO command message. It may be chosen by the operator of the access network 11, either globally for the network or cell by cell. This value of D may vary dynamically in accordance with various criteria, linked for example to the network load.

In another embodiment of the present invention, the power level captured in the cell corresponds to an energy measurement denoted CPICH_Ec/N₀ defined hereinabove. Thus CPICH_Ec/N_{0before} denotes such energy measurement received from the base station on the CPICH channel before the HHO and CPICH_Ec/N_{0after} denotes the same energy measurement received from the base station on the CPICH channel after the failure of the HHO.

In this case, the transmission power of the terminal on the first dedicated uplink radio channel after the failure of the HHO preferably satisfies the following equation:

P_{after}=P_{before}−(CPICH_{—}Ec/N_{0after}−CPICH_{—}Ec/N_{0before})+D (2)

It will be noted that the measurements CPICH_Ec/N₀ are effected on downlink signals whereas the measurements that would be the most relevant to take into account in the power balance should strictly speaking be measurements on the uplink channel, since it is the transmission power on uplink channels that is a being controlled here. The term “pathloss” that the CPICH_RSCP, referred to the transmission power of the Node B on the CPICH channel (which transmission power is known to the terminal and generally does not vary over time), represents, generally shows no very great difference between the uplink channel and the downlink channel, but the same may not apply to the level of noise generated by sources of interference, the access technology being of CDMA type. Nevertheless, equation (2) already procures a significant improvement given that the situation of interference on the uplink channel does not necessarily change greatly during the period of the timer T0.

It is possible to further improve performance by taking into account, instead of the terms N_{0before} and N_{0after}, measurements I_{0before} and I_{0after} of interference on the uplink channel that the base station 5 would supply to the terminal 10. These interference measurements are performed by the base station receiver. They may be broadcast in the cell, for example in system information, which enables the terminal to receive them before attempting the HHO and after its failure and to combine them with the power measurements CPICH_RSCP_{before} and CPICH_RSCP_{after} to calculate its new transmission power according to the equation:

P_{after}=P_{before}−(CPICH_{—}RSCP_{after}/I_{0after}−CPICH_{—}RSCP_{before}/I_{0before})+D (3)

The interference measurement I_{0before} may also be signaled to the terminal in the handover command message.

It is possible for an HHO to be required when the terminal is in an SHO or SerHO situation. If the terminal is in SHO, a plurality of links is set up with a plurality of different base stations. If the terminal is in SerHO, a plurality of links in different cells is set up with a plurality of base stations.

In this case, before attempting an HHO, the terminal stores the first power level relating to each cell of the active set with which it has an active radio link. Then, when the HHO attempt has failed, the terminal attempts again to measure the second power levels for the same cells. The terminal then determines a new transmission power as a function of the variation between the first and second power levels determined in this way.

In the following example, the power level captured from the base stations corresponds to the energy measurement CPICH_Ec/N₀ defined hereinabove. Accordingly, on the basis of the measurements CPICH_Ec/N₀ performed on the various CPICH corresponding to the cells of the active set, a combined power level denoted CPICH_Ec/N_{0combined} is supplied.

A value of the combined power level CPICH_Ec/N_{0combined} before the HHO and after the HHO is specified hereinafter as a function of different scenarios.

In the case where the terminal is in SHO (but not in SerHO), when it receives an HHO command, it determines a value CPICH_Ec/N_{0combined} preferably taking into account power levels captured from a number p of cells of the active set (for base stations that are all different). Thus a value CPICH_Ec/N_{0combined} may advantageously satisfy the equation:

CPICH_{—}Ec/N_{0combined}=Max(CPICH_{—}Ec/N₀₁, . . . , CPICH_{—}Ec/N₀ₚ) (4)

in which CPICH_Ec/N₀₁ to CPICH_Ec/N₀ₚ correspond to the respective power levels captured from the p base stations.

In the case where the terminal is in SerHO with r>1 cells managed by a single base station, it can estimate the value CPICH_Ec/N_{0combined} upon reception of an HHO command from the equation:

$$CPICH\_EC \text{/} {N}_{0 combined} = {\sum }_{i = 1}^{r} CPICH\_Ec \text{/} {N}_{0 i} \qquad ( 5 )$$

in which CPICH_Ec/N₀₁ corresponds to a power level captured from the base station comprising r radio links with the terminal for a softer handover.

In the case where the terminal is in SHO with p>1 base stations at least one of which manages a plurality of cells of the active set with which the terminal is in SerHO, the value CPICH_Ec/N_{0combined} may be determined from equation (4), the term CPICH_Ec/N₀ₖ for each base station k managing a plurality of cells of the active set being obtained beforehand by a summation of the equation (5) type.

In one embodiment of the present invention, such combination is effected a first time on reception of the HHO command and provides a first captured power level denoted CPICH_Ec/N_{0combined-before}, and then a second time after the failure of the HHO and provides a second captured power level, denoted CPICH_Ec/N_{0combined-after}.

Thus the terminal can determine the transmission power on the first dedicated uplink radio channel after the failure of the HHO from the equation:

P_{after}=P_{before}−(CPICH_{—}Ec/N_{0combined-after}−CPICH_{—}Ec/N_{0combined-before})+D (6)

Note that it is advantageous to quickly determine the new transmission power after the failure of the HHO. To this end, when the value CPICH_Ec/N_{0combined-after} has been determined, the terminal may take into account only the power levels that it is capable of capturing quickly. Thus the terminal preferably combines the power levels captured from the cells with which it can be rapidly resynchronized after the failure of the HHO.

In another embodiment, if the terminal is in SHO when it receives the HHO command, it can attempt to send with an appropriate power to at least one of the cells of the active set.

To this end, there is defined a variation Δᵢ of the power level captured from a cell i of the active set before and after the HHO. In the case described hereinafter, the power level captured corresponds to a power of reception of a signal on the CPICH channel and satisfies the equation:

Δᵢ=CPICH_{—}RSCP_{before}(i)−CPICH_{—}RSCP_{after}(i) (7)

in which CPICH_RSCP_{before}(i) is the RSCP measurement on the CPICH channel relating to the cell i before the HHO and where CPICH_RSCP_{after}(i) is the RSCP measurement on the same CPICH channel after the failure of the HHO. The variations Δᵢ that are positive are denoted Δᵢ₋ₚₒₛᵢₜᵢᵥₑ and the variations Δᵢ that are negative are denoted Δ_{i-negative}.

If at least one Δᵢ is positive, the terminal can calculate its transmission power after the failure of the HHO from the equation:

P_{after}=Pᵢₙᵢₜᵢₐₗ−Max(Δᵢ₋ₚₒₛᵢₜᵢᵥₑ)+D (8)

If none of the Δᵢ is positive, the terminal calculates its transmission power after the failure of the HHO from the equation:

P_{after}=Pᵢₙᵢₜᵢₐₗ+Min(|Δᵢ|)+D (9)

Consequently, the transmission power after the failure of the HHO is increased if all of the variations Δᵢ are negative. If at least one of the variations Δᵢ is positive, the transmission power could be reduced compared to what it was before the HHO. Thus the power used by the terminal on the dedicated uplink channel to the access network can advantageously be reduced.

A variant transmission power calculation is proposed hereinafter in the case where the terminal is in SHO. This variant ends for the optimum adaptation of the transmission power after the failure of the HHO on some or all of the radio links set up with the cells of the active set. As in the method described above, the Δᵢ relating to the various cells of the active set are calculated. If at least one Δᵢ is negative, the transmission power after the failure of the HHO may be calculated from the equation:

P_{after}=P_{before}+Max(|Δ_{i-negative}|)+D (10)

In the contrary situation, the terminal determines the transmission power from the equation:

P_{after}=P_{before}−Min(|Δ_{i-negative}|)+D (11)

Consequently, the power is increased as soon as at least one of the Δᵢ is negative. The power can be reduced only if all the Δᵢ are positive.

The terminal preferably determines the new transmission power quickly. To this end, it is advantageous for the value CPICH_RSCP_{after} to be determined only in relation to the base stations with which the terminal is quickly resynchronized after the failure of the handover.

A method of the above kind is easy to implement in an existing cellular system to improve the quality of management of terminal mobility.

1. Method of controlling the transmission power of a mobile terminal (10) in communication in a cellular radio system, the terminal (10) receiving power control commands from at least one base station of the cellular system with which a radio link (8) comprising first dedicated uplink and downlink channels is set up, the method comprising the following steps:
in response to the reception by the terminal of a command to change channels (13), storing (21) a first power level captured from said base station and a reference power with which the terminal was transmitting on the first uplink channel at the time of receiving said command and attempting (22) to continue the call on new dedicated uplink and downlink channels, the terminal ceasing to transmit on the first dedicated uplink channel;
if the continuation of the call on the new channels fails (23), estimating (24) a second power level captured from said base station and resuming transmission (26) from the terminal (10) on the first dedicated uplink channel with a power level determined (25) as a function of the stored reference power and an observed variation between said first and second power levels.

2. Method according to claim 1, wherein the mobile terminal (10) determines the first and/or the second power level captured from the base station from a reception power of a signal transmitted by the base station on a common downlink channel.

3. Method according to claim 1, wherein the mobile terminal determines the first and/or the second power level captured from the base station by calculating an energy received during a given time period from the base station in a defined frequency band on a common downlink channel.

4. Method according to claim 1, wherein, a plurality of radio links of different cells being established between the mobile terminal and one or more base stations at the time of reception of the command to change channels, the terminal determines the first power level by combining at least some of the power levels captured from said base stations in relation to said cells and wherein, if the continuation of the call on the new channels fails, the terminal estimates the second power level by combining at least some of the power levels captured from said base stations in relation to said cells.

5. Method according to claim 1, wherein the terminal further stores information relating to synchronization with the base station before attempting to continue the call on the new dedicated channels and wherein, once the continuation of the call on the new channels has failed, the terminal gets synchronized with the base station on the basis of said stored synchronization information in order to estimate the second power level.

6. Method according to claim 1, wherein the mobile terminal determines the transmission power level, once the continuation of the call on the new channels has failed, as a difference between the stored reference power and the observed variation between the first and second power levels, increased by a positive or zero power offset value.

7. Method according to claim 6, wherein the terminal determines the power offset value as a function of information received from the base station.

8. Method according to claim 1, wherein the terminal activates a timer before attempting to continue the call on the new channels and wherein the continuation of the call fails if, on the expiry (23) of said timer, the terminal has not been able to communicate on the new channels.

9. Device for controlling the transmission power of a mobile terminal (10) comprising processor means adapted to implement a method according to claim 1.

10. Mobile radio communication terminal (10), comprising:
means for communicating with at least one base station of a cellular radio system on a radio link comprising first dedicated uplink and downlink channels, the communication means comprising means for controlling the transmission power on the first dedicated uplink channel as a function of power control commands received from said base station;
means for storing, in response to the terminal receiving a command to change channels, a first power level captured from said base station and a reference power with which the terminal was transmitting on the first uplink channel at the time of receiving said command and attempting to continue the call on new dedicated uplink and downlink channels, the terminal ceasing to transmit on the first dedicated uplink channel;
means for estimating, if the continuation of the call on the new channels fails, a second power level captured from said base station and resuming sending on the first dedicated uplink channel with a power level determined as a function of the stored reference power and an observed variation between said first and second power levels.

11. Mobile terminal according to claim 10, further comprising means for determining the first and/or the second power level captured from the base station from a reception power of a signal transmitted by the base station on a common downlink channel.

12. Mobile terminal according to claim 10, further comprising:
means for determining the first power level by combining at least some of the power levels captured from said base stations, a plurality of radio links being set up between the mobile terminal and one or more base stations; and
means for estimating the second power level, if the continuation of the call on the new channels fails, by combining at least some of the power levels captured from said base stations.

13. Mobile terminal according to claim 10, further comprising means for determining the transmission power level, once the continuation of the call on the new channels has failed, as a difference between the stored reference power and the observed variation between the first and second power levels, increased by a positive or zero power offset value.
